(19) United States
(12) Patent Application Publication
(10) Pub. No.: US 2023/0103112 A1
(43) Pub. Date: Mar. 30, 2023

(54) SYSTEM AND METHOD FOR MONITORING ACTIVITY PERFORMED BY SUBJECT

(71) Applicant: Darvis Inc., San Francisco, CA (US)

(72) Inventors: Ingo Nadler, Bad Breisig (DE); Jan-Philipp Mohr, Hamburg (DE)

(21) Appl. No.: 17/487,293

(22) Filed: Sep. 28, 2021

(51) Int. Cl. G06K 9/00; G06T 7/73; G06N 3/02

(52) U.S. Cl. CPC G06K 9/00342; G06N 3/02; G06T 7/75; G06T 2207/20084

(57) ABSTRACT

Disclosed is a system for monitoring an activity performed by the subject. The system comprises a non-imaging sensor configured to detect the subject in a scan area, wherein the subject is detected by reflected waveform thereby. The system also comprises a processing arrangement communicably coupled to the non-imaging sensor, wherein the processing arrangement is configured to receive the reflected waveform from the non-imaging sensor, employ a first neural network to estimate the skeletal pose of the subject, feed a temporal succession of a plurality of skeletal poses of the subject to a second neural network, and determine the activity performed by the subject based on the temporal succession of the plurality of skeletal poses. Disclosed also is a method for monitoring an activity performed by the subject.

### TECHNICAL FIELD

The present disclosure relates generally to monitoring systems; and more specifically, to systems for monitoring activities performed by the subjects. The present disclosure also relates to methods for monitoring activities performed by the subjects using the aforementioned systems.

### BACKGROUND

In recent times, advancements in the field of computing resources and machine learning have provided a new way to visually represent the real world. Generally, the monitoring systems use image processing models to monitor activities performed by a subject and identify objects in the environment. Normally, such monitoring systems find applications in workplaces, the healthcare industry, the automotive industry, autonomous driving, traffic monitoring, educational institutions, and so forth, for monitoring for example employees, healthcare professionals and patients, workers, children, players, and so forth. Typically, monitoring systems could be image-generating systems (namely, imaging sensors), non-image generating systems (namely, non-imaging sensors), or a combination thereof, that may be used to effectively monitor local or remote areas with.

Typically, the monitoring systems such as a closed-circuit television (CCTV) are used for monitoring and providing surveillance to larger areas, such as houses, buildings, professional settings, and the like. However, such monitoring systems comprise multiple arrangements and require calibration for each of said multiple arrangements to achieve an overall accurate result. Moreover, the multiple arrangements associated with such monitoring systems increase the complexity in design and cost of installation thereof.

Recent advances in monitoring systems have limited the surveillance range to the subject and its close vicinity only. Moreover, the monitoring systems may also be used for human activity recognition to monitor the activity performed by the subject. Such monitoring systems are operable for tracking the movement of the subject by tracking the poses (namely, stance) of the subject. Typically, such monitoring systems employ artificial intelligence (AI), computer vision, machine learning, and the like, to perform image processing, monitoring, and tracking the activity of the subject. However, such monitoring systems fail to precisely recognize complex human activities being performed. Moreover, such monitoring systems fail to determine specific postures of the subject and convert them into corresponding images or videos in real-time. Typically, such monitoring systems use a combination of an imaging sensor (such as a high-resolution or a high-definition camera) to capture the subject and a non-imaging sensor, to determine the movement of the subject based on the camera feed, and thus are computationally intensive as well as time-consuming. Additionally, the existing monitoring systems are inefficient in providing privacy protection of the subject.

Therefore, in light of the foregoing discussion, there exists a need for an improved system for monitoring the activity performed by the subject.

### SUMMARY

The present disclosure seeks to provide a system for monitoring an activity performed by a subject. The present disclosure also seeks to provide a method for monitoring an activity performed by a subject. The present disclosure seeks to provide a solution to the existing problem of monitoring and tracking subjects using pose estimation in real-time without violating the privacy thereof. An aim of the present disclosure is to provide a solution that overcomes at least partially the problems encountered in prior art, and provide an efficient, robust, and cost-efficient system.

In one aspect, an embodiment of the present disclosure provides a system for monitoring an activity performed by a subject, the system comprising:
a non-imaging sensor configured to detect the subject in a scan area, wherein the subject is detected by a reflected waveform thereby; and
a processing arrangement communicably coupled to the non-imaging sensor, wherein the processing arrangement is configured to
   receive the reflected waveform from the non-imaging sensor,
   employ a first neural network to estimate the skeletal pose of the subject,
   feed a temporal succession of a plurality of skeletal poses of the subject to a second neural network, and
   determine the activity performed by the subject based on the temporal succession of the plurality of skeletal poses.

In another aspect, an embodiment of the present disclosure provides a method for monitoring an activity performed by a subject, the method comprising:
detecting, using a non-imaging sensor, the subject in a scan area, wherein the subject is detected by a reflected waveform thereby;
providing the reflected waveform to a processing arrangement;
operating the processing arrangement to feed the reflected waveform to a first neural network to estimate a skeletal pose of the subject;
operating the processing arrangement to feed a temporal succession of a plurality of skeletal poses of the subject to a second neural network; and
determining the activity performed by the subject based on the temporal succession of the plurality of skeletal poses.

Embodiments of the present disclosure substantially eliminate or at least partially address the aforementioned problems in the prior art, and provides an efficient and user-friendly system for monitoring the subject, by employing training of a neural network, and tracking changes in activity of the subject in real-time.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system, in accordance with an embodiment of the present disclosure;

FIGS. 2A and 2B, are schematic illustrations of a system, in accordance with different embodiments of the present disclosure;

FIG. 3 is a schematic illustration of a system installed in an environment for monitoring an activity performed by the subject, in accordance with an embodiment of the present disclosure;

FIG. 4 is a schematic illustration of a scan area as viewed from a non-imaging sensor, in accordance with an embodiment of the present disclosure;

FIG. 5 is a schematic illustration of a system installed in an environment, in accordance with another embodiment of the present disclosure;

FIG. 6 is an exemplary illustration of skeletal pose of an activity performed by the subject, in accordance with an embodiment of the present disclosure;

FIG. 7 is an exemplary illustration of a display screen for disoriented subjects, in accordance with an embodiment of the present disclosure; and

FIG. 8 is a flowchart of steps of a method of monitoring an activity performed by the subject, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for monitoring an activity performed by a subject, the system comprising:
a non-imaging sensor configured to detect the subject in a scan area, wherein the subject is detected by a reflected waveform thereby; and
a processing arrangement communicably coupled to the non-imaging sensor, wherein the processing arrangement is configured to
   receive the reflected waveform from the non-imaging sensor,
   employ a first neural network to estimate the skeletal pose of the subject,
   feed a temporal succession of a plurality of skeletal poses of the subject to a second neural network, and
   determine the activity performed by the subject based on the temporal succession of the plurality of skeletal poses.

In another aspect, an embodiment of the present disclosure provides a method for monitoring an activity performed by a subject, the method comprising:
detecting, using a non-imaging sensor, the subject in a scan area, wherein the subject is detected by a reflected waveform thereby;
providing the reflected waveform to a processing arrangement;
operating the processing arrangement to feed the reflected waveform to a first neural network to estimate a skeletal pose of the subject;
operating the processing arrangement to feed a temporal succession of a plurality of skeletal poses of the subject to a second neural network; and
determining the activity performed by the subject based on the temporal succession of the plurality of skeletal poses.

The present disclosure provides the aforementioned system and the aforementioned method for monitoring the activity performed by the subject. The system enables tracking poses of the subject in real time and sharing the information associated with the subject (such as a sequence of multiple poses, an activity performed by the subject as determined by the poses) with authorized users (such as those monitoring the activity of the subject). Beneficially, the convolutional neural networks (CNNs) are implemented to reduce the computational complexity of the system as it automatically detects the important features without any human intervention. Moreover, the system enables monitoring without violating the privacy and revealing any personal data or image of the subject. Beneficially, the system uses a non-imaging sensor, such as a millimeter-wave (mmwave) radar sensor, due to its low-power consumption, compact design, robust and easy installation features. Additionally, the system eliminates use of multiple arrangements, and employs available data (namely, training datasets) to train the CNNs, thereby, reducing the time required for overall calibration of the system and making the system less labor intensive.

The disclosed system provides a solution for monitoring the activity performed by the subject in real time. Throughout the present disclosure, the term “monitoring” as used herein refers to a regular observation and recording activities performed by the subject to ensure quality and documentation thereof. Optionally, the subject could be monitored when in isolation, care home, hospital, workplace, or other privacy-sensitive areas. It will be appreciated that monitoring the subject using the aforementioned system enables authorized users to record a variety of information such as actions, contributions, disciplinary actions, investigations, performance evaluations, policy violation, quality measurement, and evaluation of patient care activities in a hospital and the patient themselves, for example. In this regard, the disclosed system could be used to monitor and record how a person is performing his activities, such as a worker working in an assembly line or a nurse working in an ICU/CCU. Beneficially, the monitored activities could be directed to an aspect of Performance Management, root cause analysis, increasing efficiency, for training purposes, and so forth, at various levels for a subject.

The term “subject” as used herein refers to a person, such as a worker, an employee, a patient, a child, an athlete, a care giver, and the like. Optionally, the subject is a nurse taking care of a patient in a hospital. Optionally, the subject is a patient in a care home, hospital, or their home. Optionally, the subject may be a staff (namely worker) accommodated within a workplace, an educational institution, a warehouse, a public place, a home, a health-care facility, a gymnasium, a prison, a factory, and so forth.

Typically, monitoring of the subject could be achieved using an imaging sensor, a non-imaging sensor, or a combination thereof. Notably, the imaging sensor and the non-imaging sensors employ emission or transmission of energy in the form of waves (namely, waveform), such as light, particles, sound, and others. The waveform may interact with an object (or subject) in several ways, such as transmission, reflection, and absorption. The imaging sensor typically employs optical imaging systems (that use any of visible, near-infrared, and shortwave infrared spectrums and typically produce panchromatic, multispectral, and hyperspectral imagery), thermal imaging systems (that use mid to longwave infrared wavelengths), or synthetic aperture radar (SAR).

The term “non-imaging sensor” as used herein refers to a detection system that measures the waveform (namely, radiation) from all points in the scan area, integrates the measured data and registers a single response value for a set of observation point (for example, a single response value (dot) representing a head comprising a set of observation points, such as the eyes, nose, mouth, ears, hair, and so forth). Moreover, they may operate to enhance the evaluation or processing of the system in the scan area surrounding the subject by using the non-image sensor data to determine a relative position, orientation or activity performed by the subject. The non-imaging sensor may include but is not limited to, a radar sensor, an infrared sensor, a lidar sensor, an ultrasonic sensor, a microwave radiometer, a microwave altimeter, a magnetic sensor, a gravimeter, a Fourier spectrometer, a laser rangefinder, a laser altimeter, and the like. Unlike the imaging sensors, the non-imaging sensors do not form a conventional image of the scan area and the subject(s) being screened. Instead, the non-imaging sensors detect and analyze the effect that the body of the subject (and/or any concealed object) has on reflected waveform. Beneficially, the non-imaging sensors are inexpensive and less computationally intensive unlike the imaging sensors that are required to capture (or produce), process and store data, thereby increasing computational power as well as costing thereof.

In an embodiment, the non-imaging sensor is implemented as a radar sensor. The term “radar sensor” as used herein refers to a detection system that uses radio waves to determine motion and velocity of the subject (or any object), by figuring out change in a position, a pose, a shape, a trajectory, an angle thereof. Typically, RADAR is an acronym for RAdio Detection And Ranging, and the radar sensor transmits radio waves (waveform or microwave signal) towards the target and detects the backscattered (namely, reflected) portion of the radio waves (waveform or microwave signal). In this regard, the reflected waveform from a transmitter of the radar sensor reflects off the subject (or object) and returns to a receiver of the radar sensor, giving information about the subject’s (or object’s) location and velocity. The radar sensor is automatically activated to enter a tracking mode when the subject is in the scan area. Optionally, the non-imaging sensor is a millimeter wave (mmwave) radar sensor, such as Texas Instruments IWR 4368AOP chipset, and the like. Beneficially, the mmwave radar sensors offer a greater bandwidth, such as in a range of 3-4 GHz, thereby, providing a more precise image resolution and in turn a high-resolution mapping of the scene in range. Moreover, such a reflected waveform is safe for organisms (both humans and animals), and therefore the radar sensor finds use in a wide range of applications such as in wearable devices, smart buildings, automobiles, control systems, and so forth.

The term “scan area” as used herein refers to an area of an environment before the non-imaging sensor. It may be appreciated that the environment may be a property including, but not limited to, a room, a home or a building. Specifically, the scan area has the subject (or object) that needs to be tracked. Optionally, the scan area may be defined by the height and width (or cross-section) occupied by the subject (or object). Optionally, the scan area may have portions where only non-moving objects may be placed. The tracking of the subject (or object) may not be necessary in such portions of the scan area. Therefore, in order to conserve energy and computational cost, it will be appreciated that only those regions of the scan area where a moving subject (or object) may be tracked is selected, and portions where subject (or object) may unlikely be ever placed are ignored. It will be appreciated that the reflected waveform (reflected by the subject) is used to create a multidimensional space, such as a three-dimensional space having coordinates such as x, y and z. It is in this three-dimensional space that the reflected waveform is represented as a point cloud data. The term “point cloud data” as used herein refers to a set of data points in space. The points may represent a multidimensional shape of the subject or an object in the space. Each point position has its set of Cartesian coordinates (x, y, z). The posture is estimated by matching the subject such as a human body model to the point cloud data. The skeletal pose of the subject is represented by joints or sections of the body of the subject namely, the head, chest and waist, and the right and left, upper arms, forearms, thighs, and lower legs. Moreover, each body section is represented by multidimensional elements (such as 3 D). The elements such as cylinders, hemispheres, and elliptic columns are then combined to estimate the one or more images and temporal skeletal poses of the activity performed by the subject.

The reflected waveform is analyzed using frequencies with maximum reflectivity in the polarization of the reflected waveform obtained from the subject. Typically, the reflected waveform possesses the range, velocity and angle information of the reflection points of the subject. Moreover, the reflected waveform is used to calculate the real-world position (x, y, z) of the reflection points, with respect to the radar (at origin), where x, y, z represents the depth, azimuth and elevation coordinates, respectively.

The term “processing arrangement” as used herein refers to a set of algorithms, an application, program, a process, or a device that responds to requests for information or services by another application, program, process or device (such as the external device) via a network interface. Optionally, the processing arrangement also encompasses software that makes the act of serving information or providing services possible. It may be evident that the communication means of the external device may be compatible with a communication means of the processing arrangement, in order to facilitate communication therebetween. Optionally, the processing arrangement employs information processing paradigms such as artificial intelligence, cognitive modeling, and neural networks (such as artificial neural network (ANN), simulated neural network (SNN), recurrent neural network (RNN), convolutional neural network (CNN), and the like) for performing various tasks associated with monitoring and pose estimation of the subject.

Moreover, the processing arrangement is configured to receive the reflected waveform from the non-imaging sensor. It will be appreciated that the non-imaging sensor senses and gathers reflected waveform from the subject located in the scan area, and communicates with the processing arrangement for processing the reflected waveform. Optionally, the processing arrangement processes one or more image data received from an imaging sensor and/or training dataset for monitoring the subject, in addition to the radar data received from the non-imaging sensor.

The processing arrangement employs a first neural network to estimate the skeletal pose of the subject. In this regard the term “first neural network” as used herein refers to a network of artificial neurons programmed in software such that it tries to simulate a human brain, for example to perceive images, video, sound, text, and so forth. The first neural network typically comprises a plurality of node layers (or convolutional layers), containing an input layer, one or more intermediate hidden layers, and an output layer, interconnected, such as in a feed-forward manner (i.e. flow in one direction only, from input to output). The first neural network takes as input the reflected waveform and output, via several nodes connected to one another, an individual output.

Moreover, the neural networks are trained using at least one of: the reflected waveform, the image data, or a training dataset, to learn and improve their accuracy over time. Notably, the training dataset comprises stored images on a server. Optionally, training the neural networks could be performed through forward propagation (i.e. from input to output) as well as backpropagation (i.e. from output to input). Moreover, the neural networks are typically trained using a large collection of input and output pattern pairs in order for it to produce a specific pattern, such as the skeletal pose, as its output when it is presented with a given pattern, such as one or more images, as its input. In this regard, the neural networks could use supervised learning techniques, unsupervised learning techniques or reinforcement learning techniques for training. In this regard, a set of features are selected for training the neural network. Typically, the features are measurable properties or characteristics of a phenomenon. Specifically, the features are the variables or attributes of the dataset for training the neural network. For example, in computer vision, there are a large number of possible features, such as edges and objects. The number of nodes in the hidden layer are equal to the number of features that the network is required to learn from, and the number of nodes in the output layer are equal to the number of classes that the network is required to output. In an example, the neural network could be trained to recognize a stance of the subject, such as standing or sitting. The first layer of neurons (namely, input layer) will break up the images showing different people in different positions into areas of light and dark. This data will be fed into the next layer (namely, hidden layer) to recognize edges. The hidden layer would then try to recognize the shapes formed by the combination of edges. The data would go through several hidden layers in a similar fashion to finally recognize whether the image shown is an image of a subject standing or sitting according to the data it has been trained on.

The term “skeletal pose” as used herein refers to an orientation of a person in a graphical format. Specifically, it is a set of coordinates that can be connected to describe the pose of the subject as a skeleton. More specifically, each coordinate in the skeleton is referred to as a joint or parts, and a connection between a pair of joints is referred to as a limb. In other words, the skeleton represents a hierarchical tree structure of joints and limbs therebetween. Notably, a relative position of the joints in the skeleton is determined as the skeletal pose of the subject. It will be appreciated that every position and orientation of joints of each of the skeletal pose is stored for reference. Furthermore, different skeletal poses could be compared against a reference skeletal pose (that defines the original position and orientation of each joint). Moreover, different skeletal poses could be used to determine a skeleton-based activity recognition of the subject, as discussed later. Optionally, the joints represent a head, eyes, ears, a nose, a spine, a collar, a chest, shoulders, elbows, wrists, hands, a pelvic girdle (hips), knees, ankles and toes. Optionally, the limbs represent a face, a neck, a trunk (or abdomen), arms, legs and feet. Beneficially, the skeletal pose may be used for analyzing activity, gesture and gait recognition. Additionally, the skeletal pose may be used both in two-dimensional (2D) and three-dimensional (3D) human pose estimation techniques.

The processing arrangement is configured to feed a temporal succession of a plurality of skeletal poses of the subject to a second neural network to determine the activity performed by the subject. The term “temporal succession” as used herein refers to a correlation of order and duration to be successive to an event. In other words, temporal succession refers to an occurrence of a current event and later aspects thereof relating to time. It will be appreciated that the current event or state of the event that is updated in real time may involve a transition from a past (or earlier) event state that is different from the current event state. Moreover, the temporal succession of the plurality of skeletal poses is obtained by gathering and arranging all features in a time-stamped sequence. For example, an athlete changing poses while exercising in a gymnasium. In this regard, the plurality of skeletal poses obtained from the first neural network are used for determining the activity being performed by the subject while attaining said plurality of skeletal poses in relative temporal succession.

The term “second neural network” as used herein refers to a network of artificial neurons programmed in software such that it tries to simulate a human brain, for example to perceive the activities performed by the subject based on the temporal succession of the plurality of skeletal poses or videos. In this regard, the second neural network uses temporal succession of the plurality of skeletal poses of the subject as input to determine the activity performed by the subject as output. The term “activity” as used herein refers to performing an action by introducing one or more variations in their stance by the subject. It will be appreciated that the second neural network determines the activity performed by the subject based on the variations in the skeletal pose thereof during a pre-defined interval or in real time. Optionally, the activity performed by the subject may be a fall, workout, an action while playing a sport, a dance move, a full-body sign language, a theft, a robbery, care, and so forth. Beneficially, the second neural network reduces noise (namely, overfitting of data), and increases the computation speed of the processing arrangement to determine the activity performed by the subject based on the temporal succession of the plurality of skeletal poses of the subject. Optionally, the second neural network uses principles from linear algebra, matrix multiplication, and so on to identify temporal succession of the plurality of skeletal poses to in turn determine the associated activity performed by the subject. In an example, the activity may be turning of a patient, mounting a wheel, and so forth.

In this regard, the second neural network may be trained by feeding the temporal succession of the plurality of skeletal poses into a two-dimensional matrix containing a set of relative positions of recognized joint positions within an interval of time into a first convolutional layer and train the first convolutional layer to predict the activity performed by the subject during the said interval of time (for example, wiping a surface). Moreover, for a time series of smaller intervals of time, activity predictions may be fed in consecutive convolutional layers to predict larger or rather longer activities performed by the subject. Furthermore, the time series joint position data may be pre-processed before feeding it into the first convolutional layer by initially calculating its degree of motion. In this regard, time series joint position data segments with little or no motion may be employed to define a beginning and an end of an interval of time fed into the first convolutional layer.

It will be appreciated that one of the key challenges in human activity recognition (HAR) is that the conventional HAR methods are position dependent as estimated skeletal poses in a two-dimensional space are highly dependent on the relative position of the imaging or non-imaging sensor and the subject. Therefore, an extensive training of the neural network model using computer generated or pre-recorded poses (namely, image data) with randomized imaging sensor positions may be employed prior to using the model. Moreover, this may be achieved by setting up multiple imaging sensors in that scan area and combining their inputs as training data for training a model.

Optionally, the second neural network may be trained by running a pose estimation on the temporal succession of the plurality of skeletal poses or any video data containing human actions and labeling them, respectively. However, it will be appreciated that implementing the first neural network and the second neural network may be highly computation intensive for edge-based devices (such as NVIDIA Jetson computing arrangements, and so forth). In such cases, the plurality of skeletal pose data is processed on a master computing arrangement in real time. This enables the second neural network to be deployed on several other room sensors at once, for example to turn the temporal succession of the plurality of skeletal poses into corresponding activities.

Optionally, the system comprises sharing information associated with the activity performed by the subject with authorized users. The term “authorized user” as used herein refers to the person monitoring the subject or the one who has permission to use the shared information of the subject. Beneficially, the authorized user may use the information to make the system perform more efficiently and reduce human intervention. Moreover, the shared information may be employed for performance management, root cause analysis, increasing efficiency, training purposes, and so forth. Notably, the shared information may be utilized in workplaces, healthcare organizations, educational organizations, industries and the like.

The system further comprises an imaging sensor, operatively coupled with the non-imaging sensor. The term “imaging sensor” as used herein refers to one or more cameras comprising one or more image sensors that may be used to capture the one or more images of the subject. Optionally, the imaging sensor may capture a video of the subject. Herein, the one or more images may be frames of each of the video captured by each camera of the plurality of cameras of the imaging sensor. The term “images” as used herein refers to visual representations of a person, such as the subject, captured by the imaging sensor or provided as a training dataset. Moreover, the imaging sensor is configured to provide the one or more images to the processing arrangement to train the first neural network to estimate the skeletal pose of the subject, as discussed above. It will be appreciated that the processing arrangement trains the first neural network to use filters on the pixels of the image to learn detailed patterns corresponding thereto. The detailed patterns may be the image with a width, a height, and a channel. Moreover, training involves resetting the data, setting a batch size in a shape argument, and applying filters to learn shape and volume features of the first neural network. The calculations obtained from the one or more images are used to estimate the skeletal poses of the subject using the first neural network.

Optionally, the processing arrangement is configured to train the first neural network and the second neural network from a training dataset. The term “training dataset” as used herein refers to a set of data used to help the system to understand and create the model by testing or validating the data to improve performance. Specifically, the training dataset is used as an input for training the first neural network and the second neural network. Beneficially, the processing arrangement analyses and processes the training dataset for training the first and second neural networks to improve the efficiency of the system. Typically, the training dataset is required during the training of neural networks to make predictions and corrections when said predictions are false. The training process continues until the neural network achieves a desired level of accuracy on the training data. Notably, the joints in all the training datasets are arranged in a manner kinematically mimicking the subject. In this regard, the one or more images may be time-stamped images or temporal succession of images of the subject.

Optionally, the training dataset may be at least one of: the reflected waveform, one or more images, one or more skeletal poses, a video data, or other signals. Optionally, the video data may be a collection of one or more images, time-stamped skeletal poses or temporal succession of skeletal poses of the subject. Optionally, the video data is compared with a reference video data stored in a memory module of the system. In an example, the system may be implemented to monitor the subject exercising in a fitness studio based on a video footage obtained from the fitness studio. Here, a reference video data is used to check if the exercise is performed correctly, split both the videos into phases, and detect joints in each frame of both the videos. The training dataset is used to compare each phase of an exercise performed by the subject after the joints are detected and exercise phases defined in both the videos. As used herein, the term “signals” refers to the signals received from different types of detection systems. Optionally, the detection system may be a LIDAR sensor, SONAR sensor, infrared signals sensors, and so forth. The LIDAR sensor is similar to the radar sensor but makes use of other wavelength ranges of the electromagnetic spectrum, such as infrared radiations from lasers rather than radio waves. The infrared signals provide an infrared image for training the first neural network. Alternatively, the training dataset could be audio data that may be used by suitable non-imaging sensors for training the first and the second neural networks.

It will be appreciated that the method comprises training the first and second neural networks using the training dataset to employ only the reflected waveform to determine the activity performed by the subject. Notably, the training dataset may comprise a different type of training data that may be specific to train a type of neural network. In an example, the training data could be an image data that could be used to train the first neural network to estimate skeletal poses based on the image data. In another example, the training data could be a video data that could be used to train the second neural network to estimate the activity performed by the subject based on the temporal succession of the plurality of skeletal poses. It will be appreciated that the training data is received from a memory module or directly from the imaging sensor.

Optionally, the imaging sensor is a wide-angle camera or fish-eye to obtain a 180 ° vertical view and a 180 ° horizontal view of the subject. The wide-angle camera typically has a smaller focal length that enables capturing a wider area to be captured. The fisheye camera is an ultra-wide-angle camera configured to create a wide panoramic or hemispherical image (or non-rectilinear image). Optionally, the fisheye camera captures an angle of view of around 100-180 ° vertically, horizontally and diagonally. Optionally, the imaging sensor provides a 360 ° view using a specialized fisheye 360 ° dome camera.

Optionally, the imaging sensor is further configured to dewarp the one or more images. The term “dewarp” as used herein refers to correction of distortions of images obtained from the imaging sensor such as a wide-angle camera or the fish-eye camera. The processing arrangement dewarps the one or more images (and/or camera image from one or more slave devices) and passes the dewarp image(s) for further processing.

Optionally, the imaging sensor further comprises an illuminator configured to illuminate the area during capturing of the one or more images. The illuminators are configured to illuminate the area during capturing of the one or more images during night. Examples of a given illuminator include, but are not limited to, infrared (IR) illuminators, light emitting diode (LED) illuminators, IR-LED illuminators, white-light illuminators, and the like. Beneficially, the emitted light of the infrared wavelength or the near-infrared wavelength is invisible (or imperceptible) to the human eye, thereby, reducing unwanted distraction when such light is incident upon the subject’s eye.

Optionally, the processing arrangement is configured to train the first neural network by:
running a pose estimation model on the one or more images to estimate one or more skeletal poses based thereon; and
using the one or more skeletal poses to train the first neural network to convert the reflected waveform into a corresponding skeletal pose.

In this regard, the term “pose estimation model” as used herein refers to an algorithm that enables estimating one or more skeletal poses of the subject using several technologies such as computer vision, artificial intelligence, and so forth. Optionally, the pose estimation model may be a skeleton-based, a contour-based, a volume-based model, and the like. Moreover, the pose estimation model is run on the one or more images to determine different groups of joints present in the body of the subject. It will be appreciated that the pose estimation model is invariant of the size of the image and can predict pose positions in any scale of the image, normal, upscaled or downscales, for example. Additionally, a multidimensional pose estimation model may be used to determine a multidimensional spatial arrangement of all the subject’s joints as well as limbs connecting a pair of joints as its final output. For example, using a three-dimensional (3D) pose estimation model for determining a three-dimensional spatial arrangement of all the body joints and limbs connecting a pair of joints as its final output. It will be appreciated that the one or more skeletal poses are then used to compare joints frame by frame and detect change in skeletal pose during a period of time.

In this regard, the pose estimation model receives as input image data (from the imaging sensor or training dataset) and generates information about joints as output. Typically, the joints detected are assigned a reference identity corresponding with the body part of the subject. Optionally, the reference ID is weighed as a confidence score between 0.0 and 1.0, wherein the confidence score indicates the probability that a joint exists in that position. Optionally, the pose estimation model follows a top-down approach. In a top-down approach, the pose estimation model incorporates a detector unit that detects the subject(s) in the image followed by estimating the joints and limbs for the detected subject(s) and calculating a corresponding pose for the subject (s). Optionally, the pose estimation model follows a bottom-up approach. In the bottom-up approach, the pose estimation model detects all joints of the subject(s) in the image and associates (or groups) the joints for each of the subject(s) using associating (or grouping) algorithms.

It will be appreciated that the one or more skeletal poses identified using the pose estimation model is used to train the first neural network to convert the reflected waveform into a corresponding skeletal pose. In this regard, the reflected waveform that generates the point cloud data could be used as a point cloud image data. The point cloud image data is used to determine the joints and corresponding limbs to generate skeletal poses of the subject without requiring images to be captured by the imaging sensor associated with the disclosed system. It will be appreciated that the system learns by methods such as artificial intelligence, deep learning, and so forth, and implements CNN using a large training dataset.

Optionally, the processing arrangement is configured to train the second neural network by:
running a pose estimation model on temporal succession of a plurality of images or a video data to estimate temporal successive poses based thereon; and
using the temporal successive poses to train the second neural network to convert the temporal succession of a plurality of skeletal poses into a corresponding activity performed by the subject.

In this regard, as discussed above, the pose estimation model trains using a large training dataset, such as using a temporal succession of the plurality of skeletal poses and determined from the first neural network, or a video data that can be labelled. Moreover, the processing arrangement trains the second neural network by iteratively refining the skeletal poses obtained from the first neural network. Furthermore, the processing arrangement runs the pose estimation model for feature extraction and reduces the size of the skeletal pose data fed to the second neural network. The term “temporal successive poses” as used herein refers to a successive change in poses of the subject relative to a previous pose thereof. It will be appreciated that the temporal successive poses lead to a video effect resulting in an activity being performed corresponding to the temporal successive poses. Therefore, such temporal successive poses may be used to train the second neural network to estimate the activity being performed by the subject corresponding to the temporal successive poses. It will be appreciated that the trained second neural network could use the reflected waveform only to determine the activity being performed by the subject corresponding to the temporal successive poses, without requiring receiving a video data from the imaging sensor of the disclosed system.

Optionally, the first neural network and the second neural network are trainable Convolutional Neural Networks. The term “Convolutional Neural Networks” or “CNNs” as used herein refers to a specialized type of neural network model developed for working with multidimensional image data such as 1D, 2D, 3D, and so forth. The convolutional neural networks consist of an input layer, hidden layers and an output layer (collectively referred to as ‘convolutional layers’). The CNN is employed to perform a linear operation called convolution. Alternatively, the CNN is a series of nodes or neurons in each layer of the CNN, wherein each node is a set of inputs, weight values, and bias values. As an input enters a given node, it gets multiplied by a corresponding weight value and the resulting output is either observed, or passed to the next layer in the CNN. Typically, the weight value is a parameter within a neural network that transforms input data within hidden layers of the neural network. The CNN comprises a filter that is designed to detect a specific type of feature in the one or more images and skeletal pose data. Beneficially, the CNN shares the weight values at a given layer, thus reducing the number of trainable parameters compared to an equivalent neural network. Furthermore, the CNN is trained to extract features from the images using a feature map. For example, the CNN may be trained to extract features that are useful for classifying images of the activity performed by the subject such as standing, bending, sitting, walking, and so forth.

Optionally, the processing arrangement is further configured to implement machine learning algorithms, deep learning and skeletal tracking algorithms to analyze the training dataset. Typically, such algorithms are a step-by-step computational procedure for solving a problem, similar to decision-making flowcharts, which are used for information processing, mathematical calculation, and other related operations. The term “machine learning algorithm” as used herein refers to a subset of artificial intelligence (AI) in which algorithms are trained using training datasets. For example, the training dataset may be a historical data stored in a memory module of the system to predict outcomes, future trends and draw inferences from patterns of the one or more images or skeletal poses. The term “deep learning algorithm” as used herein refers to an algorithm that runs data through several neural network algorithms, each of which passes a simplified representation of the data to the next layer. It will be appreciated that the deep learning algorithms are trained to learn progressively more about the training datasets as it goes through each neural network layer. Moreover, early layers of the neural network learn how to detect low-level features like edges, and subsequent layers combine features from earlier layers into a more holistic representation. For example, a middle layer might identify edges to detect parts of the subject in the photo such as a leg or an arm, while a deep layer will detect the full activity of the subject such as walking or bending. Furthermore, the term “skeletal tracking algorithms” as used herein refers to algorithms that analyse the cluster of data (such as reflected waveform and/or one or more images) to estimate the skeletal poses or temporal succession of skeletal poses of the subject. Notably, the aforementioned algorithms reduce the computational complexity and provide powerful computing units to process the plurality of skeletal poses into the activities performed by the subject(s). Moreover, the aforementioned algorithms also help the system to estimate the pose from any video data containing human actions and labelling them respectively. Beneficially, the aforementioned algorithms improve the performance of the system by reducing the time required by the system to estimate the pose.

Optionally, the activity performed by the subject is determined by
(a) detecting the skeletal pose of the subject;
(b) defining a bounding box corresponding to the skeletal pose;
(c) defining an aspect ratio of the bounding box;
(d) observing a change in the aspect ratio resulting from a successive skeletal pose;
(e) repeating iteratively the step (d) until no change in the aspect ratio is observed for a pre-defined interval; and
(f) determining the activity performed by the subject based on the temporal succession of the plurality of skeletal poses.

In this regard, the non-imaging sensor is activated when the subject is located in the scan area. The reflected waveform from the subject is received by the receiver of the non-imaging sensor and analyzed to track the skeletal pose of the subject based on the point cloud generated from the reflected waveform. It will be appreciated that based on the point cloud, a change in the wave frequency or Doppler effect is observed and said change is associated with at least one skeletal pose of the subject.

Moreover, the skeletal pose of the subject is estimated or detected using the relative positions of skeletal joints of the subject. Therefore, based on the skeletal pose, a bounding box is defined for the skeletal pose. The term “bounding box” as used herein refers to the border that fully encloses the skeletal pose of a subject in the scan area to determine one or more dimensions associated with the subject. In this regard, the processing arrangement is configured to determine one or more dimensions associated with the subject. The one or more dimensions may be physical dimensions, such as, but not limited to length, breadth, width, height, angle made by different body parts, specifically the joints, with respect to a central axis of the skeletal pose of the subject.

Furthermore, for a given bounding box, an aspect ratio of the given bounding box is defined. The term “aspect ratio” as used herein refers to a ratio of a longer side of a geometric shape, in this case, the height of the skeletal pose of the subject, to its shorter side, in this case, the width of the skeletal pose of the subject. In an embodiment, the aspect ratio is a ratio of the height of the bounding box to the width thereof if the bounding box is oriented as a portrait as a reference. In another embodiment, the aspect ratio is a ratio of the width of the bounding box to the height thereof if the bounding box is oriented as a landscape as a reference. It will be appreciated that two aspect ratios of the bounding box may be relative to each other. Specifically, if a first aspect ratio is obtained for the bounding box in the portrait-orientation, then a second aspect ratio is also obtained for the bounding box in the portrait-orientation. It will be appreciated that defining an aspect ratio of the bounding box can be performed as an alternative to skeletal pose estimation for detecting a fall. Beneficially, performing either of the two may save computational power.

The term “change in the aspect ratio” as used herein refers to a difference in the values of two aspect ratios when measured as a function of time (pre-defined interval). The change may be a rapid (or sudden) change or a slow change as measured during a period of time. The change in the aspect ratio corresponds to a change in successive skeletal pose of the subject. The term “pre-defined interval” as used herein refers to a set time period to observe the change in the aspect ratio of the bounding box. Iteratively calculating change in aspect ratio until no change in the aspect ratio is observed for the pre-defined interval produces the temporal succession of the plurality of skeletal poses. Furthermore, combining temporal succession of the plurality of skeletal poses to determine the activity of the subject. The change in successive skeletal pose leads to a change in the activity performed by the subject. Optionally, the activity includes, but not limited to, hand movement, leg movement, head movement, life sign physiological parameters, such as heartbeat frequency, respiratory movements, muscle movements, and so on. Moreover, no change in the aspect ratio observed for a pre-defined interval is associated with a rest position of the subject.

It will be appreciated that alternate systems, such as LIDAR, similar to radar but using other wavelength ranges of the electromagnetic spectrum, such as infrared radiations from lasers rather than radio waves, could be used. It will be appreciated that the LIDAR and other systems deliver a point cloud data to be analyzed.

Optionally, the system further comprises
a communication interface having
   a display screen configured to display text or graphics thereon,
   a microphone configured to receive an audio input from the subject, and
   a speaker configured to provide an audio output to the subject; and
a memory module, communicably coupled to the processing arrangement, wherein the memory module is configured to store skeletal pose data associated with the subject, the activity performed thereby, and the training dataset, for use by the processing arrangement.

In this regard, optionally, the communication interface includes, but are not limited to, microphone, display screen, touch screen, optical markers, and speakers. The display screen is typically large enough to show in big size (namely, clearly) the text and graphics, comprising pictures and/or videos. Examples of the display screen include, but are not limited to, a Liquid Crystal Display (LCD), a Light-Emitting Diode (LED)-based display, an Organic LED (OLED)-based display, a micro OLED-based display, an Active Matrix OLED (AMOLED)-based display, and a Liquid Crystal on Silicon (LCoS)-based display. The microphone may be used to receive the audio input from the subject. Further, the audio input from the subject may be sent to the processing arrangement in real-time. Optionally, the audio input may be pre-recorded by the subject using the microphone for play-back using the speaker, as required. Moreover, the speaker may be used to play music or provide instructions to the subject. Furthermore, the speakers enable the subject to hear out the text or graphics displaying on the display screen. Furthermore, the communication interface may be used to update at least one of: display of graphics and text on the display screen. Herein, the memory module may be any storage device implemented as hardware, software, firmware, or combination of these. In an embodiment, the memory module may be a primary memory such as a read only memory (ROM) and a random-access memory (RAM), that may be faster. In another embodiment, the memory module may be a secondary memory, such as hard disk drives, secondary storage disks, floppy disks and the like.

Alternatively, in an embodiment, the system for monitoring an activity performed by a subject does not comprise a communication interface. In such a case, the system may for example not include a display screen and/or a touch screen, therefore limiting the interaction of the subject with the environment outside the scan area.

Optionally, one or more slave devices, communicably coupled to the processing arrangement, are arranged in one or more areas outside the scan area, wherein the one or more slave devices provide at least one of: the reflected waveform or the one or more images to the processing arrangement. The term “slave device” as used herein refers to one or more additional devices, arranged in one or more areas outside the scan area, that function similarly to the system as disclosed above. Each slave device may have a non-imaging sensor (such as for example a radar sensor) and/or an imaging sensor similar in configuration or function to the non-imaging sensor and the imaging sensor of the system, respectively. Optionally, the one or more slave devices are configured to provide one or more images of the reflected waveform corresponding to the one or more areas other than the scan area of the environment to the processing arrangement. The one or more slave devices are connected to the system through a wireless or cabled network interface. At an implementation level, the one or more slave devices configure the radar sensor or the imaging sensor thereof to send one or more images or reflected waveform for analysis to the system. Furthermore, the one or images or reflected waveform received from the one or more slave devices are then transferred to the processing arrangement to determine the activity performed by the subject. Notably, the one or more slave devices and the system coordinate their function to monitor the activity performed by the subject, such as to monitor the subject and track the change in pose and provide the corresponding thereof. Beneficially, the one or more slave devices may also analyse the environment to detect smoke and/or fire outbreaks.

The present disclosure also relates to the method as described above. Various embodiments and variants disclosed above apply mutatis mutandis to the method.

Optionally, the method comprises operating the processing arrangement to:
train the first neural network by:
   running a pose estimation model on one or more images to estimate one or more skeletal poses based thereon, and
   using the one or more skeletal poses to train the first neural network to convert the reflected waveform into a corresponding skeletal pose; and
train the second neural network by:
   running a pose estimation model on temporal succession of a plurality of images or a video data to estimate temporal successive poses based thereon; and
   using the temporal successive poses to train the second neural network to convert the temporal succession of a plurality of skeletal poses into a corresponding activity performed by the subject.

Optionally, the method comprises operating the processing arrangement to implement machine learning algorithms, deep learning algorithms and skeletal tracking algorithms to analyze the training dataset.

Optionally, the method comprises determining the activity performed by the subject by
(a) detecting a skeletal pose of the subject;
(b) defining a bounding box corresponding to the skeletal pose;
(c) defining an aspect ratio of the bounding box;
(d) observing a change in the aspect ratio resulting from a successive skeletal pose;
(e) repeating iteratively the step (d) until no change in the aspect ratio is observed for a pre-defined interval; and
(f) determining the activity performed by the subject based on the temporal succession of the plurality of skeletal poses.

Optionally, the method comprises sharing information associated with the activity performed by the subject with authorized users.

Optionally, the method comprises arranging one or more slave devices, communicably coupled to the processing arrangement, in one or more areas outside the scan area, wherein the one or more slave devices provide at least one of: the reflected waveform or the one or more images to the processing arrangement.

Optionally, the method comprises:
receiving the training dataset;
applying a training data from the training dataset to the first neural network;
computing, by the first neural network, a first set of point cloud data corresponding to the subject;
generating a skeletal pose of the subject with respect to the first set of point cloud data;
applying one or more skeletal poses of the subject to the second neural network;
computing, by the second neural network, a second set of point cloud data corresponding to the temporal succession of the plurality of skeletal poses; and
determining the activity performed by the subject with respect to the temporal succession of the plurality of skeletal poses.

The term “first set of point cloud data” and the “second set of point cloud data” as used herein refers to data that is used to determine the skeletal poses and the activity performed by the subject, respectively. Optionally, the first set of point cloud data is obtained at a pre-defined time interval. Optionally, the second set of point cloud data is obtained in real time to give a temporal succession of the plurality of skeletal poses.

The present disclosure also relates to the computer program product as described above. Various embodiments and variants disclosed above apply mutatis mutandis to the computer program product.

A computer program product comprising a non-transitory computer-readable storage medium having computer-readable instructions stored thereon, the computer-readable instructions being executable by a processing arrangement to execute the aforementioned method.

### DETAILED DESCRIPTION OF THE DRAWINGS

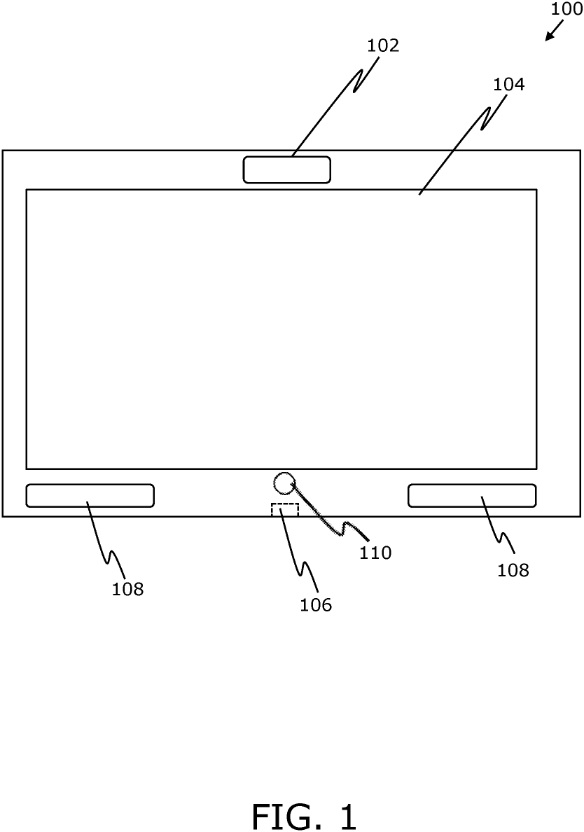

Referring to FIG. 1, illustrated is a system 100 for monitoring an activity performed by the subject, in accordance with an embodiment of the present disclosure. The system 100 comprises a non-imaging sensor 102 and a processing arrangement (not shown). The non-imaging sensor 102 is configured to detect the subject in the scan area by using a reflected waveform thereby. The processing arrangement is configured to receive the reflected waveform from the non-imaging sensor 102, employ a first neural network to estimate the skeletal pose of the subject, feed a temporal succession of a plurality of skeletal poses of the subject to a second neural network, and determine the activity performed by the subject based on the temporal succession of the plurality of skeletal poses. The system 100 further comprises a communication interface comprising a display screen 104, a microphone 106, and a speaker 108.

The display screen 104 is configured to display text or graphics thereon. The microphone 106 is configured to receive an audio input from the subject. The speaker 108 is configured to provide an audio output to the subject. The system 100 also comprises an imaging sensor 110. The imaging sensor 110 is configured to capture one or more images of the scan area. The system 100 further comprises a memory module (not shown), communicably coupled to the processing arrangement to store skeletal pose data associated with the subject, the activity performed thereby, and the training dataset, for use by the processing arrangement.

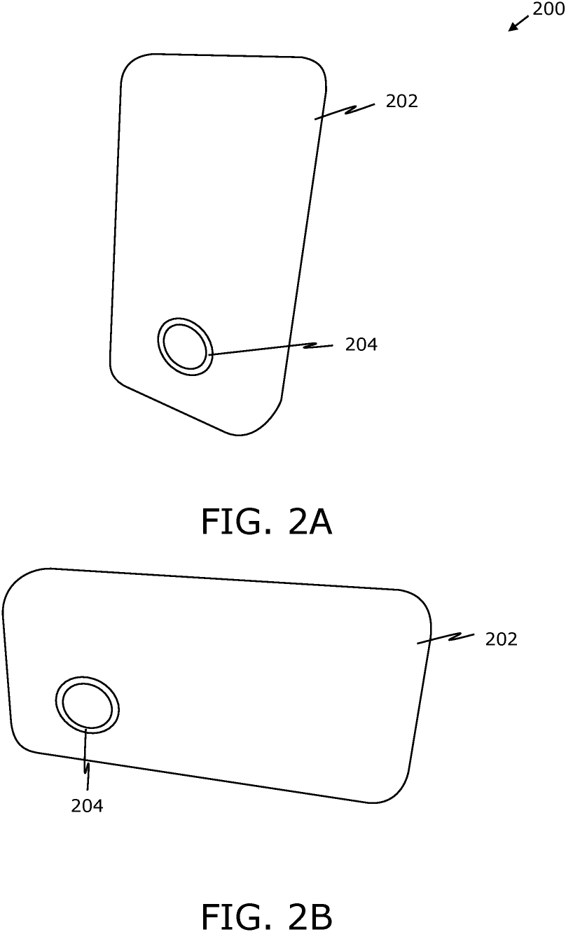

Referring to FIGS. 2A and 2B, illustrated are schematic illustrations of a system 200, in accordance with different embodiments of the present disclosure. The system 200 may be mounted in a vertical orientation (as shown in FIG. 2A) or in a horizontal orientation (as shown in FIG. 2B) in an environment. The system 200 comprises a housing 202 that houses a non-imaging sensor, such as the non-imaging sensor 102 as explained in FIG. 1, and an imaging sensor 204 (such as the imaging sensor 110 as explained in FIG. 1).

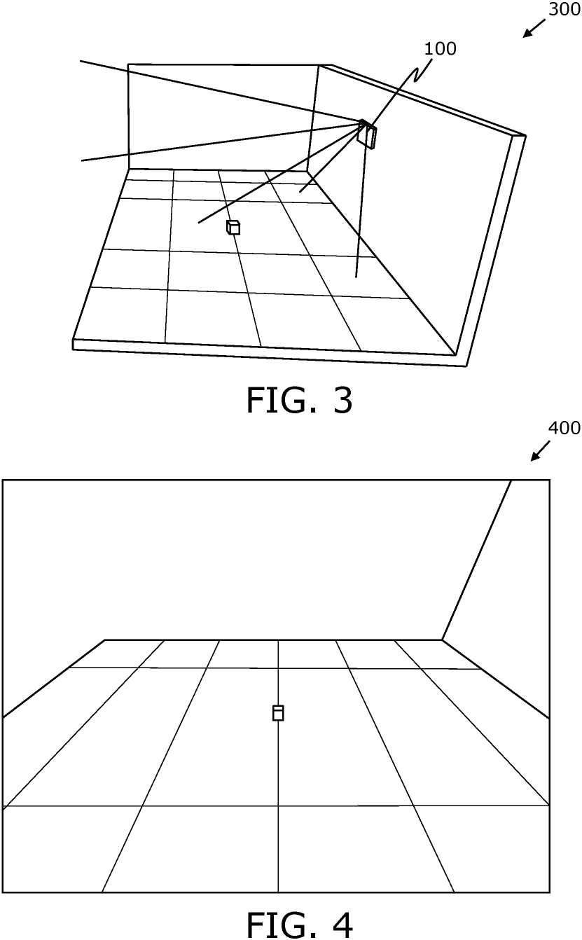

Referring to FIG. 3, illustrated is a system 100, installed in an environment 300 for monitoring an activity performed by the subject, in accordance with an embodiment of the present disclosure. As shown the environment 300 is a wall of a room. The system 100 is mounted at a height such that the non-imaging sensor is at a pre-defined height such that the subject is visible top to bottom and width wise, such as for example above eye level of an adult person. As shown the lines or rays emanating from the non-imaging sensor of the system 100 represents the exemplary reflected waveform that is employed to detect the subject in the radar coverage area.

Referring to FIG. 4, illustrated is a scan area 400 as viewed from the non-imaging sensor, in accordance with an embodiment of the present disclosure.

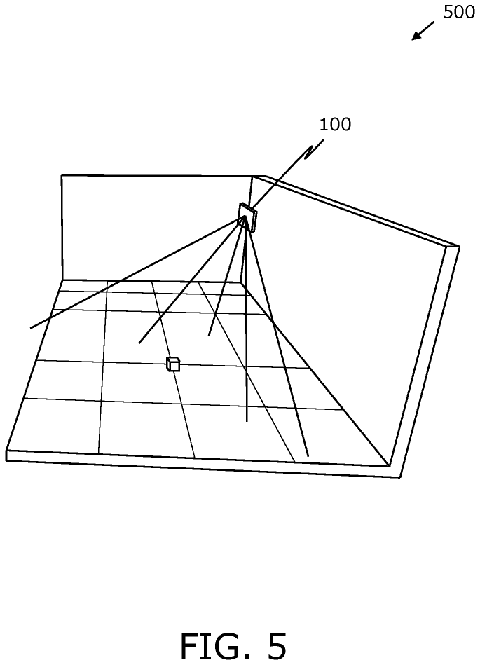

Referring to FIG. 5, illustrated is a system 100, installed in an environment 500, in accordance with another embodiment of the present disclosure. As shown in FIG. 5, the environment 500 is a corner of a wall of a room. In this regard, the system 100 may be mounted at any corner of the wall of the room due to the compact size and easy installation thereof. The system 100 is mounted at a height such that the non-imaging sensor is at a pre-defined height such that the subject is visible top to bottom and width wise, such as for example above the eye level of an adult person. As shown, the lines or rays emanating from the non-imaging sensor of the system 100 represents the exemplary reflected waveform that is employed to detect the subject in the radar coverage area.

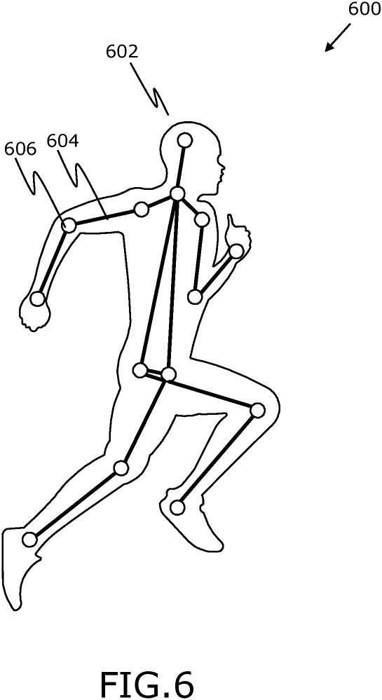

Referring to FIG. 6, there is shown a classical line representation 600 of a skeletal pose of a subject 602, in accordance with an embodiment of the present disclosure. As shown, the skeletal pose comprises joints such as a joint 604, and limbs, such as a limb 606, joining a pair of joints. It will be appreciated that the skeletal pose indicates a ‘running’ activity performed by the subject.

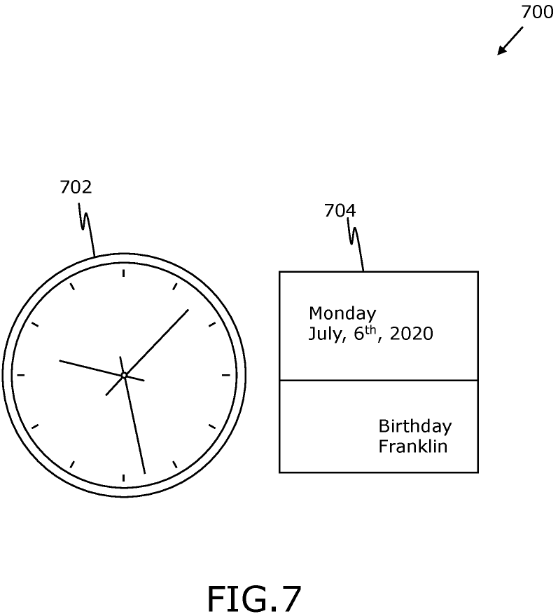

Referring to FIG. 7, there is shown an exemplary illustration 700 of a display screen, in accordance with an embodiment of the present disclosure. As shown, the display screen displays a large customizable wall clock 702, and an information text box 704 showing a current day or date, and a reminder from an internal calendar.

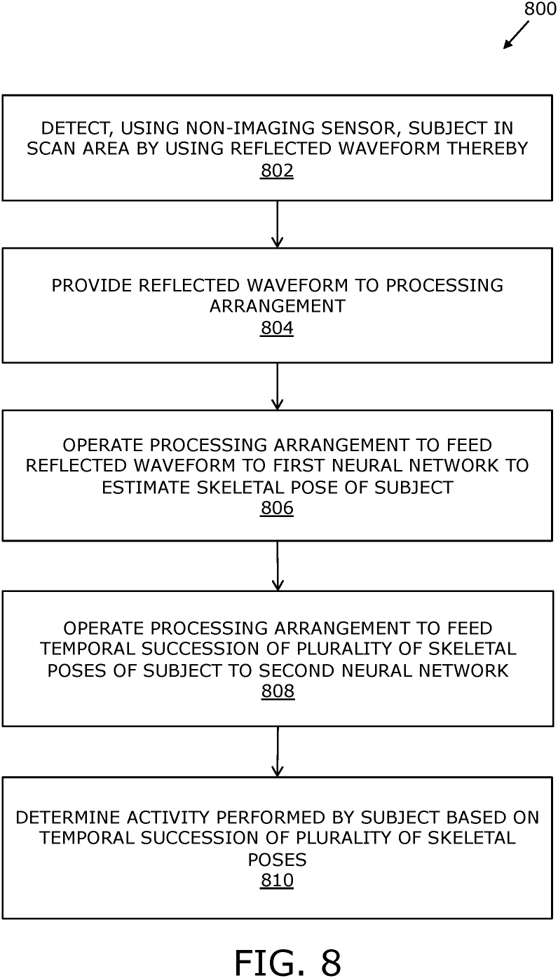

Referring to FIG. 8, there is shown a flowchart 800 of steps of a method of monitoring an activity performed by a subject, in accordance with an embodiment of the present disclosure. At step 802, the subject in a scan area is detected by using a reflected waveform thereby. At step 804, the reflected waveform is provided to a processing arrangement. At step 806, the processing arrangement is operated to feed the reflected waveform to a first neural network to estimate a skeletal pose of the subject. At step 808, the processing arrangement is operated to feed a temporal succession of a plurality of skeletal poses of the subject to a second neural network. At step 810, the activity performed by the subject is determined based on the temporal succession of the plurality of skeletal poses.

The steps 802, 804, 806, 808 and 810 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for monitoring an activity performed by a subject, the system comprising:
a non-imaging sensor configured to detect the subject in a scan area, wherein the subject is detected by a reflected waveform thereby; and
a processing arrangement communicably coupled to the non-imaging sensor, wherein the processing arrangement is configured to
receive the reflected waveform from the non-imaging sensor,
employ a first neural network to estimate the skeletal pose of the subject,
feed a temporal succession of a plurality of skeletal poses of the subject to a second neural network, and
determine the activity performed by the subject based on the temporal succession of the plurality of skeletal poses.

2. A system according to claim 1, further comprising an imaging sensor, operatively coupled with the non-imaging sensor, configured to:
capture one or more images of the subject; and
provide the one or more images to the processing arrangement to train the first neural network to estimate the skeletal pose of the subject.

3. A system according to claim 1, wherein the processing arrangement is configured to train the first neural network and the second neural network from a training dataset, wherein the training dataset is selected from at least one of: the reflected waveform, one or more images, one or more skeletal poses, a video data, or other signals.

4. A system according to claim 1, wherein the processing arrangement is configured to train the first neural network by:
running a pose estimation model on the one or more images to estimate one or more skeletal poses based thereon; and
using the one or more skeletal poses to train the first neural network to convert the reflected waveform into a corresponding skeletal pose.

5. A system according to claim 1, wherein the processing arrangement is configured to train the second neural network by:
running a pose estimation model on temporal succession of a plurality of images or a video data to estimate temporal successive poses based thereon; and
using the temporal successive poses to train the second neural network to convert the temporal succession of a plurality of skeletal poses into a corresponding activity performed by the subject.

6. A system according to claim 1, wherein the first neural network and the second neural network are trainable Convolutional Neural Networks.

7. A system according to claim 1, wherein the processing arrangement is further configured to implement machine learning algorithms, deep learning algorithms and skeletal tracking algorithms to analyze the training dataset.

8. A system according to claim 1, wherein the activity performed by the subject is determined by:
(a) detecting a skeletal pose of the subject;
(b) defining a bounding box corresponding to the skeletal pose;
(c) defining an aspect ratio of the bounding box;
(d) observing a change in the aspect ratio resulting from a successive skeletal pose;
(e) repeating iteratively the step (d) until no change in the aspect ratio is observed for a pre-defined interval; and
(f) determining the activity performed by the subject based on the temporal succession of the plurality of skeletal poses.

9. A system according to claim 1, wherein the system comprises sharing information associated with the activity performed by the subject with authorized users.

10. A system according to claim 1, further comprising:
a communication interface having
a display screen configured to display text or graphics thereon,
a microphone configured to receive an audio input from the subject, and
a speaker configured to provide an audio output to the subject; and
a memory module, communicably coupled to the processing arrangement, wherein the memory module is configured to store skeletal pose data associated with the subject, the activity performed thereby, and the training dataset, for use by the processing arrangement.

11. A system according to claim 1, wherein one or more slave devices, communicably coupled to the processing arrangement, are arranged in one or more areas outside the scan area, wherein the one or more slave devices provide at least one of: the reflected waveform or the one or more images to the processing arrangement.

12. A system according to claim 1, wherein the non-imaging sensor is a millimetre-wave radar arrangement.

13. A system according to claim 1, wherein the imaging sensor is a wide-angle camera or fish-eye camera.

14. A system according to claim 1, wherein the imaging sensor is further configured to dewarp the one or more images.

15. A method for monitoring an activity performed by a subject, the method comprising:
detecting, using a non-imaging sensor, the subject in a scan area, wherein the subject is detected by a reflected waveform thereby;
providing the reflected waveform to a processing arrangement;
operating the processing arrangement to feed the reflected waveform to a first neural network to estimate a skeletal pose of the subject;
operating the processing arrangement to feed a temporal succession of a plurality of skeletal poses of the subject to a second neural network; and
determining the activity performed by the subject based on the temporal succession of the plurality of skeletal poses.

16. A method according to claim 15, wherein the method comprises operating the processing arrangement to:
train the first neural network by:
running a pose estimation model on one or more images to estimate one or more skeletal poses based thereon, and
using the one or more skeletal poses to train the first neural network to convert the reflected waveform into a corresponding skeletal pose; and
train the second neural network by:
running a pose estimation model on temporal succession of a plurality of images or a video data to estimate temporal successive poses based thereon; and
using the temporal successive poses to train the second neural network to convert the temporal succession of a plurality of skeletal poses into a corresponding activity performed by the subject.

17. A method according to claim 15, wherein the method comprises operating the processing arrangement to implement machine learning algorithms, deep learning algorithms and skeletal tracking algorithms to analyze the training dataset.

18. A method according to claim 15, wherein method comprises determining the activity performed by the subject by:
(a) detecting a skeletal pose of the subject;
(b) defining a bounding box corresponding to the skeletal pose;
(c) defining an aspect ratio of the bounding box;
(d) observing a change in the aspect ratio resulting from a successive skeletal pose;
(e) repeating iteratively the step (d) until no change in the aspect ratio is observed for a pre-defined interval; and
(f) determining the activity performed by the subject based on the temporal succession of the plurality of skeletal poses.

19. A method according to claim 15, wherein the method comprises sharing information associated with the activity performed by the subject with authorized users.

20. A method according to claim 15, wherein the method comprises arranging one or more slave devices, communicably coupled to the processing arrangement, in one or more areas outside the scan area, wherein the one or more slave devices provide at least one of: the reflected waveform or the one or more images to the processing arrangement.

21. A method according to claim 15, the method comprises:
receiving the training dataset;
applying a training data from the training dataset to the first neural network;
computing, by the first neural network, a first set of point cloud data corresponding to the subject;
generating a skeletal pose of the subject with respect to the first set of point cloud data;
applying one or more skeletal poses of the subject to the second neural network;
computing, by the second neural network, a second set of point cloud data corresponding to the temporal succession of the plurality of skeletal poses; and
determining the activity performed by the subject with respect to the temporal succession of the plurality of skeletal poses.

22. A computer program product comprising a non-transitory computer-readable storage medium having computer-readable instructions stored thereon, the computer-readable instructions being executable by a processing arrangement to execute a method as claimed in claim 15.
